(19) United States
(12) Patent Application Publication
(10) Pub. No.: US 2017/0352098 A1
(43) Pub. Date: Dec. 7, 2017

(54) CUSTOMER IDENTIFICATION PROGRAM ACCOUNT INTEGRATION

(71) Applicant: ConnectYourCare, LLC, Hunt Valley, MD (US)

(72) Inventors: David ROBERTS, Cookeysville, MD (US); Brian STROM, Baltimore, MD (US)

(21) Appl. No.: 15/170,526

(22) Filed: Jun. 1, 2016

(51) Int. Cl. G06Q 40/06

(52) U.S. Cl. CPC G06Q 40/06

(57) ABSTRACT

Disclosed herein are system, method, and computer program product embodiments for integrating Customer Identification Program (CIP) processing performed by a bank with contribution funded processing specified by an employer. An embodiment operates by enabling a CIP processing system to configure a management database to store a temporal threshold specified by and received from an employer. Upon receiving an employee's CIP status from a bank performing the CIP processing to enable access to an account, a CIP configuration component of the CIP processing system may generate an employee indicator based on the received CIP status and the temporal threshold. The employee indicator may be associated with an employer contribution funding amount and an employee contribution funding amount.

### BACKGROUND

A contribution funded account (CFA) may be a tax-advantaged financial account that is set up through, for example, a cafeteria plan provided by an employer. A cafeteria plan is an employee benefit plan that may allow for contributions from an employee's pre-tax earnings to fund his or her CFA at the end of each pay period, contributions from the employee's employer to fund the CFA, or both contributions from the employee and the employer. The cafeteria plan is typically a year-long plan that may be updated or annually renewed. As the plan year progresses and employee or employer contributions from each pay period are added to the CFA, an employee may gain access to an increasing amount of funds from the his CFA to pay for qualified expenses as established in the cafeteria plan.

The employee's CFA may be set up at a bank and administered by a plan manager that communicates with the bank. Before enrolling the employee into the CFA, however, the bank is required by financial laws and regulations, e.g. USA Patriot Act Section 326, to institute a Customer Identification Program (CIP) to verify the employee's identity, to ensure the employee is not using the account for any illegal activity, such as fraud, money laundering, or terrorism. Based on the bank's specific procedures for implementing the CIP, the bank may attempt to verify the employee's identity within a set period of time before indicating that the employee's identity could not be verified. Therefore, the employee's identity verification may be indeterminate for up to that set period of time. In the meantime, employers may continue sending employee or employer funded contributions to the plan manager administering the CFA.

If the employee fails the CIP, the plan manager may need to coordinate with the employer to reconcile contributions sent by the employer to fund the CFA while the employee was undergoing the CIP. No tailored process exists that enables the employer to specify contribution funding decisions based on the employee's current CIP status. Furthermore, the delay in notifying the plan manager of an employee's CIP status from the bank may additionally increase the processing time needed to reconcile contribution-based funds of the CFA between the employer and the plan manager, and the employer and the employee.

### BRIEF DESCRIPTION OF THE DRAWINGS

The accompanying drawings are incorporated herein and form a part of the specification.

FIG. 1 is an example block diagram illustrating the multiple systems of entities involved in providing streamlined Customer Identification Program (CIP) processing, according to an example embodiment.

FIG. 2 is an example block diagram illustrating the components within an employer accounts system for configuring an employee's account and contribution funding decisions, according to an example embodiment.

FIG. 3 is an example block diagram illustrating the components within a bank accounts system for performing CIP, according to an example embodiment.

FIG. 4 is an example block diagram illustrating the components within a plan management system for reducing reconciling time due to CIP processing, according to an example embodiment.

FIG. 5 is a sequence diagram illustrating a process for reducing reconciling time due to CIP processing, according to an example embodiment.

FIG. 6 is a flowchart illustrating a process for determining an employee indicator based on a status of CIP processing performed by a bank, according to an example embodiment.

FIG. 7 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for reducing the processing time and resources needed upon Customer Identification Program (CIP) resolution to automatically reconcile contribution-based funds of an employee's contribution funded account (CFA) between the employer and the plan manager, and the employer and the employee. Embodiments enable a plan manager to communicate an indication of an employee's status within a CIP administered by a bank. The indication may correspond to employer-specified contribution rules that indicate contribution funding amounts based on an employee's progress through the CIP. In an embodiment, to further reduce reconciliation time, the plan manager may store an employer-specified temporal threshold that triggers the plan manager to update an employee's status before the employee's CIP status is resolved by the bank.

The CFA may be any tax-advantaged financial account that is set up by an employee through, for example, a cafeteria plan of the employer. The cafeteria plan selected by the employee may allow an employee to contribute a portion of his pre-tax earnings at the end of each pay period to fund the CFA according to the cafeteria plan. Depending on the CFA type as specified by the employer-provided cafeteria plan, the CFA may be employer funded, employee funded, or both employer and employee funded. The funds within the CFA may be used to pay for qualified expenses as established by eligible service restrictions in the cafeteria plan for that CFA. The CFA may include, for example, a health savings account (HSA), a health reimbursement account (HRA), a flexible spending account (FSA) (such as a health FSA, a dependent care FSA, a limited-purpose FSA, or an adoption related FSA), or another type of account such as a wellness account.

Additionally, the CFA, such as an HSA, may provide accelerated access to funds within the CFA through a corresponding contribution funded on-demand account. For example, the HSA may itself be comprised of two sub-accounts: the traditional HSA (HSAT) that is employer or employee funded, and an HSA OnDemand (HSAOD). The contribution funded on-demand account, HSAOD, may be initialized with a sum of contributions to be made in a plan year, while the HSAT may contain a zeroed balance. In an embodiment, the HSAT may contain a preexisting balance from the previous plan year. As contribution amounts from each pay period are added to the HSAT, the same contribution amounts are deducted from the HSAOD to maintain total available funds within the HSA including the HSAT and the HSAOD. Therefore, a contribution from a pay period effectively transfers the specified contribution amount from the HSAOD to the HSAT. By enabling an employee accelerated access to future contributions stored within the HSAOD, the employee may more likely be able to pay for larger qualified expenses starting from the first day of the plan year. Greater detail for providing an on-demand based account is provided in reference to U.S. Provisional Application No. 62/131,057.

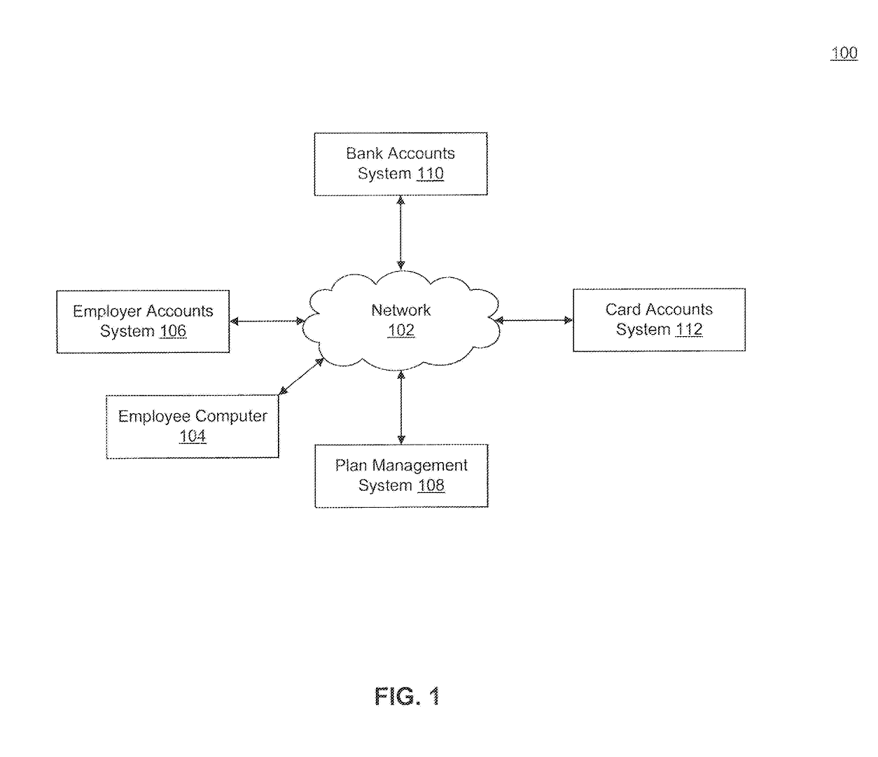

FIG. 1 illustrates CIP processing system 100 for reducing processing time to reconcile CIP resolution with funds within CFAs across multiple entities including an employer, an employee, a bank, a card vendor, and a plan manager, according to an embodiment. CIP processing system 100 includes network 102, employee computer 104 operated by the employee, employer accounts system 106 of the employer, plan management system 108 of the plan manager, bank accounts system 110 of the bank, and card accounts system 112 of the card vendor. Each of the systems or computers may be implemented using one or more processors. Although the systems are depicted as remote systems connected via network 102 in CIP processing system 100, one or more systems may be operated by or maintained by one entity. For example, bank accounts system 110 and card accounts system 112 may be part of a single system operated by one entity.

Network 102 may enable plan management system 108 to communicate with and administer the CFA across the multiple systems: employer accounts system 106, bank accounts system 110, and card accounts system 112. A communication received at plan management system 108 from bank account system 110 may include an employee's CIP status indicating whether the employee's identity has been verified. In an embodiment, employee computer 104 may communicate with and view CFA information stored on any of the depicted systems. In an embodiment, employee computer 104 may access a web portal provided by plan management system 108 via network 102. The web portal functions as an interface for viewing CFA information associated with one or more of the depicted systems. Network 102 may be an enterprise wide area network (WAN) utilizing Ethernet communications, although other wired and/or wireless communication techniques, protocols and technologies may be used.

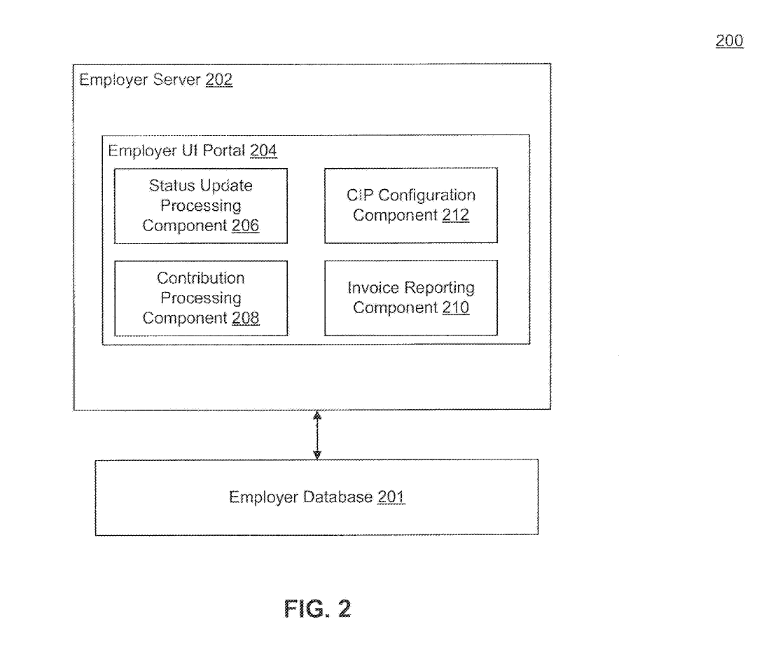

FIG. 2 illustrates employer accounts system 200 maintained by an employer for interacting with plan management system 108 to configure the CFA and contribution funding decisions, according to an exemplary embodiment of employer accounts system 106. Employer accounts system 200 may include employer server 202 and employer database 201. Though depicted as a single server, employer server 202 may be representative of a plurality of servers, each of which may be implemented by one or more processors. Likewise, employer database 201 may be representative of a plurality of databases coupled to a plurality of employer servers.

Employer database 201 may be configured to store employee information, employer cafeteria plan offerings, and employee selections of cafeteria plan offerings. Employee information may include census information, salaries, or employment statuses. An employer's cafeteria plan offering may enable an employee to select one or more CFAs, each CFA being one of the following: an HSA, an HRA, an FSA, or another tax-advantaged financial account. In an embodiment, one or more of the selected accounts may be additionally user-customized (e.g. have an On-Demand portion or be a limited purpose account). The employee may additionally reselect a cafeteria plan per annum, adjust contribution amounts to fund the CFAs, and decide whether funds of one or more CFAs are to be invested. In an embodiment, employer database 201 may also store CFA information and associated transaction logs. Transaction logs may, for example, track contributions and claims made towards one or more of the CFAs within an employee's cafeteria plan.

For more efficient CIP integration and to reduce reconciliation time, employer database 201 may be configured to store contribution rules specifying employee and employer contributions to a CFA based on employee indicators determined by plan management system 108. In an embodiment, a contribution rule may match an employee indicator to contributions decisions. For example, for an employee indicator marking the employee as undergoing CIP (e.g. a RISK status), a matching contribution rule may match the specific employee indicator to a decision to enable employee funded contributions and to a decision to disable employer funded contributions.

In an embodiment, employer database 201 may be configured to store a temporal threshold indicating when an employee indicator should be updated to reflect a CLOSED status if CIP has not been resolved. In an embodiment, the temporal threshold may be a maximum number of days since CIP has been initiated for an employee or a number of days before the set period of time specified by a bank's CIP.

Employer server 202 may be configured to configure employer user interface (UI) portal 204. Employer UI portal 204 may include status update processing component 206, contribution processing component 208, CIP processing component 212, and invoice reporting component 210. One or more of these depicted components may be implemented as processing systems comprising one or more sub-components. These sub-components may include an interface for communicating within and/or across systems and a distribution component for sending information to other components and/or across systems. For example, contribution processing component 208 may be implemented as a contribution processing system including an interface for receiving information and a distribution component for sending information.

Generally, employer UI portal 204 may be configured to allow an employer, particularly cafeteria plan administrators of the employer, to manually adjust or input the following features through the use of various components as will be discussed: contribution rules, temporal thresholds, employee statuses, employer's cafeteria plan offerings, employee selections of the cafeteria plan offerings, and information indicating contribution amounts from employees or employers to the CFA. One or more of the adjustments to the listed features may be stored in employer database 201. One or more of the adjustments may be sent to plan management system 108, which updates the employee's selected cafeteria plan managed and administered at plan management system 108.

In an embodiment, employer UI portal 204 may only adjust and view employer or employee contributions as specified by an employer's cafeteria plan. Other contributions, such as contributions that are outside of the employer's cafeteria plan and made by an employee through an employee UI portal of employer computer 104, may not be viewable. In addition to viewing details, employer UI portal 204 may be configured to provide analytics and report generation capabilities.

Status update processing component 206 within employer UI portal 204 may be configured to enable an employer to input information related to an employee's cafeteria plan selected from the employer's cafeteria plan offerings. For example, status update processing component 206 may enable an employer to input information to adjust an employee's enrollment within one or more CFAs of the selected cafeteria plan. Accordingly, status update processing component 206 may send update information to plan management system 108 that administers and updates the employee's cafeteria plan. In an embodiment, information for updating the cafeteria plans may include information indicating enrollment of a new or existing employee into one or more CFAs in accordance with an employee's selected cafeteria plan. For enrollment, status update processing component 206 may additionally be configured to send census and eligibility information of the employee, which may be retrieved from employer database 201.

In an embodiment, status update processing component 206 may be configured to enable the employer to input and send updates regarding the employer's provided cafeteria plan offerings to plan management system 108. For example, for a plan year, the employer may decide to enable its employees to select a limited-purpose HRA that only pays for pharmaceutical services as part of its cafeteria plan offerings. This update in the employer's cafeteria plan offerings may need to be sent to plan management system 108 such that an employee's selected cafeteria plan may be accurately configured and reflected in plan management system 108.

Contribution processing component 208 may be configured to process and manage an employee's contributions, an employer's contributions, or both employee and employer contributions to one or more CFAs of the employee's selected cafeteria plan per pay period. Based on employee enrollment and update information stored in employer database 201, contribution processing component 208 may generate a contributions file specifying a proportion of every employee's income (or alternatively an actual contribution amount) for a pay period. In an embodiment, the contribution file may only contain contribution information of select employees, e.g. employees enrolled in the employer's cafeteria plan offerings. Accordingly, the generated contributions file may be sent to plan management system 108 for each pay period.

Contribution processing component 308 may then receive a contributions funding request (CFR) from plan management system 108 specifying a proportion of the contribution amounts specified in the sent contributions file that must be transmitted from employer accounts system 200 to plan management system 108. The actual contribution amounts to be transmitted might not match the amounts in the contributions file for any number of reasons. For example, plan management system 108 may determine, for an employee, that he does not exist in plan management system 108, he has not enrolled in a CFA, his CFA has not been enabled or is terminated, or his designated employee contribution amount exceeds a specified maximum amount. In these cases, the employee's contribution amount may not be included in the CFR. Upon receipt of the CFR generated by plan management system 108, contribution processing component 108 may send the contribution amounts within the CFR to plan management system 108.

CIP processing component 212 may be configured to set up the contributions rules discussed above and store the contribution rules in employer database 201. In an embodiment, the employer may also configure and store the threshold time discussed above via CIP processing component 212. Upon configuration, CIP processing component 212 may send the contributions rules or threshold time to plan management system 108 to be used in faster and more efficient CIP resolution reconciliation. The contributions rules or threshold time may be used by plan management system 108 to generate the CFR. For example, a contribution rule may indicate that for an employee with a RISK status, any employer funded contributions should be disabled. Accordingly, plan management system 108 will remove the employer funded contributions for that employee in the CFR based on that contribution rule.

In an embodiment, CIP processing component 212 may be configured to receive a periodically generated employee indicator file (EIF) from plan management system 108. The EIF may be received bi-weekly or quarterly, etc., and not necessarily on a weekly basis. In an embodiment, the EIF may be received concurrently with the CFR. The EIF contains a list of employees and respective employee indicators. In an embodiment, the EIF may only include employee indicators that have changed since the last time an EIF was sent to CIP processing component 212.

Invoice reporting component 210 may be configured to periodically receive and report invoices generated by plan management system 108. In an embodiment, invoice reporting component 210 may receive an employer weekly funding request (EWFR) detailing payback records and billing records for employees enrolled in the cafeteria plans as provided by the employer's cafeteria plan offerings. The EWFR may be received from plan management system 108. In an embodiment, the employer funding request may be sent bi-weekly or quarterly, etc., and not necessarily on a weekly basis. The invoices may be utilized to reconcile contribution funds of the CFA between employer accounts system 200 and plan management system 108, and between the employer accounts system 200 and the employee.

In an embodiment, the employer may choose to withhold employer funded contributions to the CFA per pay period if the employer's CIP status is indeterminate. Here, the employer may configure a contribution rule matching a RISK status, representative of the employee's indeterminate CIP status, to a decision to enable employee funded contributions and to a decision to disable employer funded contributions. In an embodiment, the contribution rule may instead match to a proportion or an amount value of contributions. For example, a match to a zeroed employer funded contribution amount may be equivalent to disabling employer funded contributions.

In an embodiment, if the employee is subsequently verified by the CIP, the EWFR received by invoice reporting component 210 may include a billing record indicating a total sum of withheld employer funded contributions to be provided by the employer to fund the CFA. In an embodiment, the received EWFR may not include the total sum. Instead, upon receiving an employee indicator from plan management system 108, CIP processing component 212 may determine contribution funding decisions or amounts based on contribution rules stored in employer database 201. Then, contribution processing component 208 may send withheld employee or employer funded contributions in the periodic CFR or in a separate withheld contributions file (WCF).

For example, an employer may send employer funded contributions twice a year on June 1^{st} and on December 1^{st}. But, CIP processing component 212 may receive an employee indicator after June 1^{st}, indicating that an employee has passed CIP on, for example, June 2^{nd}. In an embodiment, contribution processing component 208 may then send any employer funded contributions withheld on June 1^{st} with the periodic CFR or the WCF. In an embodiment, contribution processing component 208 may instead send contributions withheld on June 1^{st} with the next scheduled employer contributions funding date of December 1^{st}.

In an embodiment, the employer may choose to not withhold employer funded contributions to the CFA per pay period if the employer's CIP status is indeterminate. Here, the employer may configure a contribution rule matching a RISK status, representative of the employer's indeterminate CIP status, to a decision to enable employee funded contributions and to a decision to enable employer funded contributions. In an embodiment, the contribution rule may instead match to a proportion or an amount value of contributions. For example, a match to 100% of employer funded contribution may be equivalent to enabling employer funded contributions.

In an embodiment, if the employee subsequently fails CIP, the employer may want to recover the total employer funded contributions supplied by the employer to fund the CFA. Here, the EWFR received by invoice reporting component 210 may include a payback record indicating a total sum of employer funded contributions the employer wishes to recover from the employee. In an embodiment, remaining funds within the CFA may be deducted and the payback record may include the total sum of employer funded contributions less the remaining funds within the CFA up to the total sum of employer funded contributions.

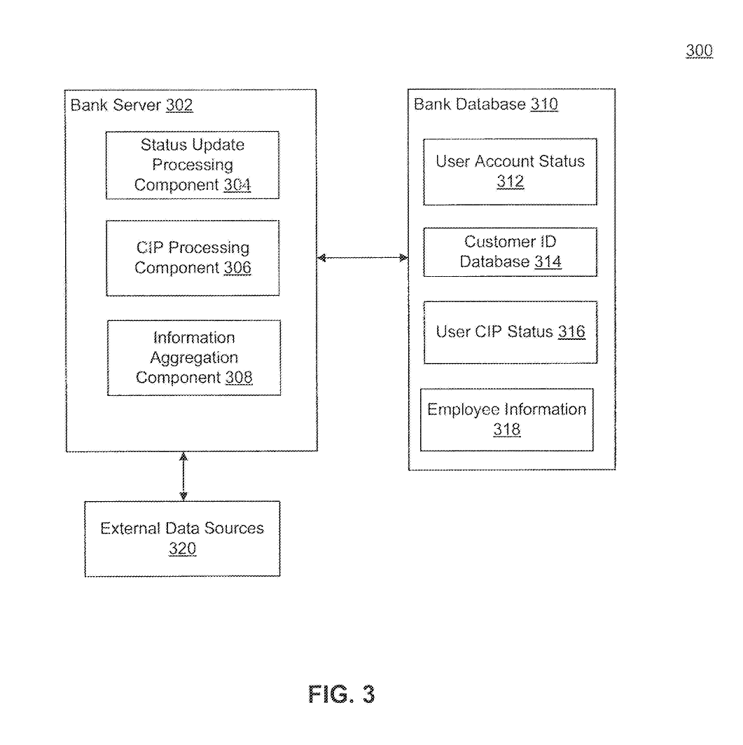

FIG. 3 illustrates bank accounts system 300 maintained by a bank for implementing CIP and hosting an employee's CFA, according to an exemplary embodiment of bank accounts system 110. Bank accounts system 300 may include bank server 302 and bank database 310. Though depicted as a single server, bank server 302 may be representative of a plurality of servers, each of which may be implemented by one or more processors. Likewise, bank database 310 may be representative of a plurality of databases coupled to a plurality of bank servers. Additionally, one or more of the depicted components may be implemented as processing systems comprising one or more sub-components. These sub-components may include an interface for communicating within and/or across systems and a distribution component for sending information to other components and/or across systems.

Bank server 302 may be configured to include status update processing component 304, CIP processing component 306, and information aggregation component 308. Status update processing component 304 may be configured to communicate with a status update processing component within plan management system 108 to synchronize an employee's CFA with a proxy CFA stored and managed at plan management system 108. Information of the employee's CFA, such as balances or account type, may be stored in user account status 312 tables of bank database 310.

In an embodiment, communications may include closing a CFA account. Particularly, status update processing component 304 may be configured to receive a request from an employee to close one of the CFAs within user accounts status 312. Accordingly, status update processing component 304 may update records stored in bank database 310, such as by changing a status of the designated CFA to closed in user accounts status 312. Then, status processing component 304 may send the changed status to plan management system 108.

In an embodiment, status update processing component 304 may be configured to receive enrollment information from plan management system 108 to enroll an employee into one or more CFAs of the selected cafeteria plan. Status update processing component 304 may be additionally configured to store the enrollment information within employee information 318 tables of bank database 310. As discussed, a bank may be required by financial laws and regulations to implement a CIP for verifying an employee's identity when enrolling the employee into a CFA hosted by the bank. The CIP may be one process by which banks detect employees associated with illegal activities and prevent such employees from using their funds for fraud, money-laundering, or terrorism. Therefore, the received enrollment information may include information needed to perform CIP.

Enrollment information stored in employee information 318 database may include one or more pieces of information from the following non-exhaustive list of an employee's personal information that may be used to perform the bank's CIP: a legal name, a date of birth, a residential or business address, and an identification number. The identification number may include a Taxpayer Identification Number such as a Social Security Number or a passport number. For a non-US citizen, additional personal information may include an alien identification card number, or number and country of issuance of a foreign government-issued document evidencing nationality or residence.

When enrolling an employee within the CFA, status update processing component 304 may request CIP processing component 306 to perform a bank-specific CIP. To perform the CIP, CIP processing component 306 may attempt to match one or more pieces of received employee information against databases of known persons to verify the employee's identity. In an embodiment, the employee's information may be matched against local databases, such as customer ID database 314 on bank database 310. Customer ID database 314 may contain information of previous customers whose identities were previously verified.

In an embodiment, the employee's information may be matched against information retrieved by information aggregation component 308. Information aggregation component 308 may be configured to pull information of known persons from customer ID database 314 or external data sources 420. In an embodiment, information aggregation component 308 may be configured to transmit the employee's information to a third-party identity verification service for verifying the employer's identity.

External data sources 320 may be representative of employee identification information stored at databases external to bank database 310. In an embodiment, external data sources 320 used for verifying an employee's identity during CIP processing may include the credit bureau, public criminal records, or other third-party data sources.

In a conventional bank accounts system 110, CIP processing component 306 generates simple employee CIP statuses based on the received employee information and the matching process described above. These employee CIP statuses may be stored in user CIP status 316 tables in bank database 310. CIP processing component 306 may periodically send an Account Status File (ASF) including the employees' CIP statuses stored in user CIP status 316 to plan management system 108. Often, the CIP statuses of all employees are sent by CIP processing component 306.

Though bank accounts system 300 receives employee information 318 from plan management system 108, which in turn receives employee information 318 from employer accounts system 106, CIP processing component 306 may request and receive employee information from the employees directly. For example, according to a bank's CIP, CIP processing component 306 may be configured to send a set number of additional information requests to the employee. These requests for further information may be sent via email, mail, or phone.

In an embodiment, the current CIP status determined by the bank for an employee and his associated CFA may include any of the following statuses: ACTIVE, CIP or PENDING, and CLOSED.

The ACTIVE status indicates that the employee's identity has been verified during CIP processing and that the CFA is formally activated. The employee's identity may have been verified during initial CIP processing or after additional employee information has been received and processed.

The CIP or PENDING status indicates that the employee's identity could not be verified during initial processing and that further personal information may need to be retrieved from the employee before the employee's identity can be verified.

Finally, the CLOSED status indicates that the employee failed CIP processing and that the employee's CFA is to be closed. For example, the employee's identity may not have been verified within a set period of time as specified by the bank's CIP procedure. In another example, the bank may have found that the employee is associated with individuals prohibited from using CFAs, such as individuals associated with money laundering and terrorism—two types of activities that the CIP procedure was designed to catch and prevent. As part of closing the employee's CFA, status update processing component 304 may liquidate and send any remaining funds within the CFA to the employee.

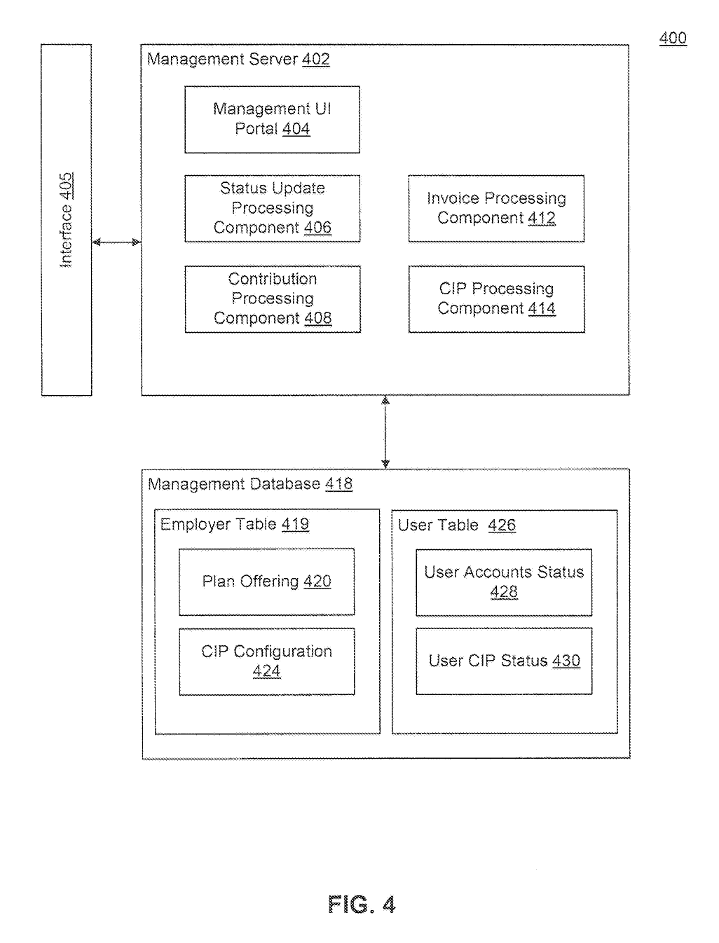

FIG. 4 illustrates plan management system 400 maintained by a plan manager for reducing processing time for reconciling CIP resolution with the contribution funds of the employee or employer, according to an exemplary embodiment of plan management system 108. Plan management system 400 may include interface 405, management server 402, and management database 418. Though depicted as a single server, management server 402 may be representative of a plurality of servers, each of which may be implemented by one or more processors. Likewise, management database 418 may be representative of a plurality of databases coupled to a plurality of management servers. Management database 418 may be implemented on one or more storage devices.

Interface 405 may be configured to enable plan management system 400, specifically management server 402, to communicate with one or more of the systems depicted in FIG. 1. Though depicted as a separate component, interface 405 may be implemented within management server 402, according to an exemplary embodiment.

Management database 418 may be configured to store employer information and employee information via one or more database tables. Employer information, stored in employer table 419, may include employer cafeteria plan offerings, stored in plan offering 420, and related information or restrictions as described in FIG. 2. In an embodiment, employer table 419 may store any employer-specific contribution rules within CIP configuration 424. As described in FIG. 2, a contribution rule may match an employee indicator with two contribution funding decisions: an employer contribution funding decision and an employee contribution funding decision. CIP configuration 424 may also store the temporal threshold specified by an employer.

Employee information, stored in user table 426, may include various information such as census information, employment status, associated employer, elected employer plan, employee contribution amounts, CFA account information, and other information related to the CFA(s) of the employee-selected cafeteria plan. In an embodiment, employee information may also include investment information such as a proportion of funds within a linked CFA that are currently allocated for investing. Investment information may be received from investment entities via file and web services. In an embodiment, information related to an employee's CFA including account balances and operating status may be stored in user accounts status 428.

An account balance of an on demand sub-account of a CFA may represent future contributions of the plan year less any amount borrowed to service a claim, as detailed in U.S. Provisional Application No. 62/131,057. To maintain any on demand sub-account tied to the employee's CFA, user accounts status 428 may additionally include an amount borrowed field to reflect a current amount of on demand sub-account funds borrowed to service one or more claims less any amount repaid via an employee's periodic contributions.

In an embodiment, an operating status of a CFA hosted at a bank may include ACTIVE, CLOSED, PENDING, or SUSPENDED. An on demand sub-account associated with the employee's CFA may be associated with the following operating statuses: ACTIVE, FROZEN, IN-COLLECTION, or CLOSED. These statuses may be unique due to the properties of an on demand sub-account. A FROZEN state may indicate that funds of the on demand sub-account may not be accessible and transferred to the traditional sub-account of the CFA to enable an employee accelerated access to future contributions. The FROZEN status may be set if, for example, an employee elects to invest funds within his or her CFA. The IN-COLLECTION status may be set when an employee's CFA is terminated because, for example, the employee leaves the employer before the end of the plan year.

In an embodiment, user status 430 within user table 426 may store current employee indicators that management server 402 has derived based on CIP statuses received from bank accounts system 110. User status 430 may additionally store the CIP statuses received from bank account system 110.

Management server 402 may be configured to include management UI portal 404, status processing component 406, contribution processing component 408, invoice processing component 412, and CIP processing component 414. One or more of the depicted components may be implemented as processing systems comprising one or more sub-components. These sub-components may include an interface for communicating within and/or across systems and a distribution component for sending information to other components and/or across systems.

Management UI portal 404 may be configured to allow a plan manager and its employees the capability to adjust and maintain employee statuses, employers' cafeteria plan offerings, and information related to an employee's CFA. Adjustments made within management UI portal 404 may be propagated to employer accounts system 106, bank accounts system 110, and/or card accounts system 112. In an embodiment, management UI portal 404 may be configured to allow the plan manager to view details of employee CFAs such as CFA statuses, CFA balances, transactions of claims filed per employee, and transactions related to employee or employer funded contributions to CFAs for each employer serviced by plan management system 108. In addition to viewing details, management UI portal 404 may be configured to provide analytics and report generation capabilities.

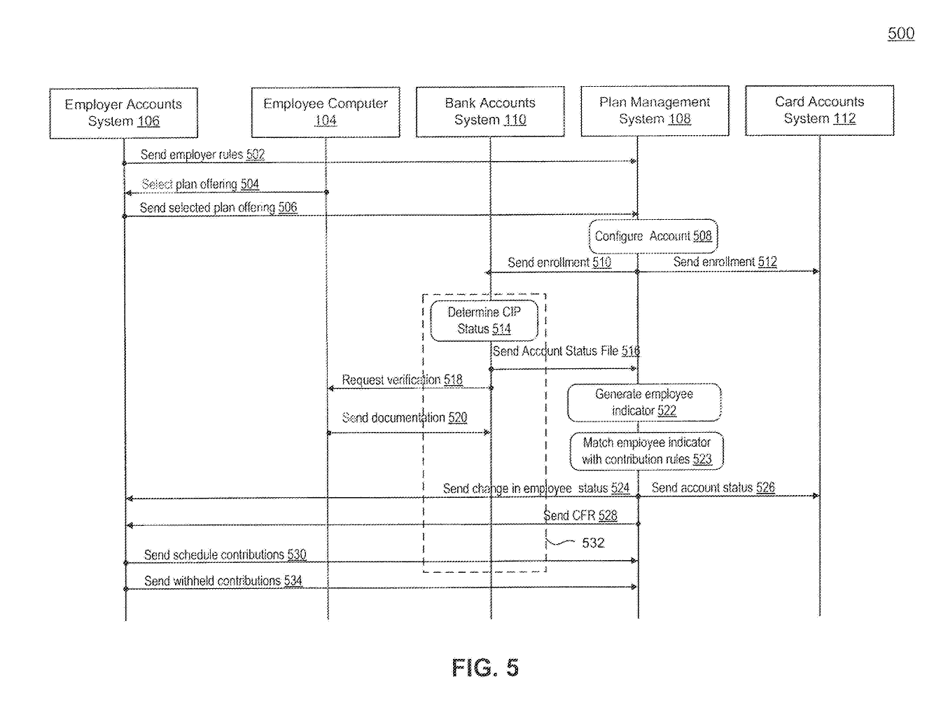

Status update processing component 406 may be configured to communicate with status update processing component 206 in employer accounts system 200 in order to reconcile updates to an employee's CFA or cafeteria plan across the multiple systems of FIG. 1, including plan management system 108, bank accounts system 110, and card accounts system 112. For example, status update processing component 406 may receive a request from employer accounts system 108 for updating an employee's CFA. Accordingly, status update processing component 406 may update records stored in management database 418, such as user accounts status 428. Then, status update processing component 406 may initiate a reconciliation process and send update information to bank accounts system 110 and card accounts system 112. In an embodiment, updating the CFA may include enrolling a new or existing employee into a CFA in accordance with an employee-selected employer cafeteria plan. The enrollment process is further discussed with regards to FIG. 5.

As discussed with regards to FIG. 3, a bank may need to verify an employee's identity through the bank's CIP as part of enrolling the employee within the CFA. CIP processing component 414 may be configured to receive CIP statuses from bank accounts system 110, such as bank accounts system 300. Then, CIP processing component 414 may derive employee indicators based on the received CIP statuses and one or more of the employer-specific rules stored within CIP configuration 424.

In an embodiment, CIP processing component 414 may forward these employee indicators to employer accounts system 200. Based on these received employee indicators and CIP contribution rules stored within employer databases 201, contribution processing component 208 within employer account system 200 may adjust contribution funds, settle withheld contribution funds, or settle transmitted contribution funds.

In an embodiment, a CIP contribution rule may match a type of employee indicator with whether to enable an employer contribution and with whether to enable an employee contribution. CIP processing component 414 may generate, for example, one or more of the following five types of employee indicators: PASS, RISK, CLOSED CIP, RESOLVED, and CLOSED OTHER.

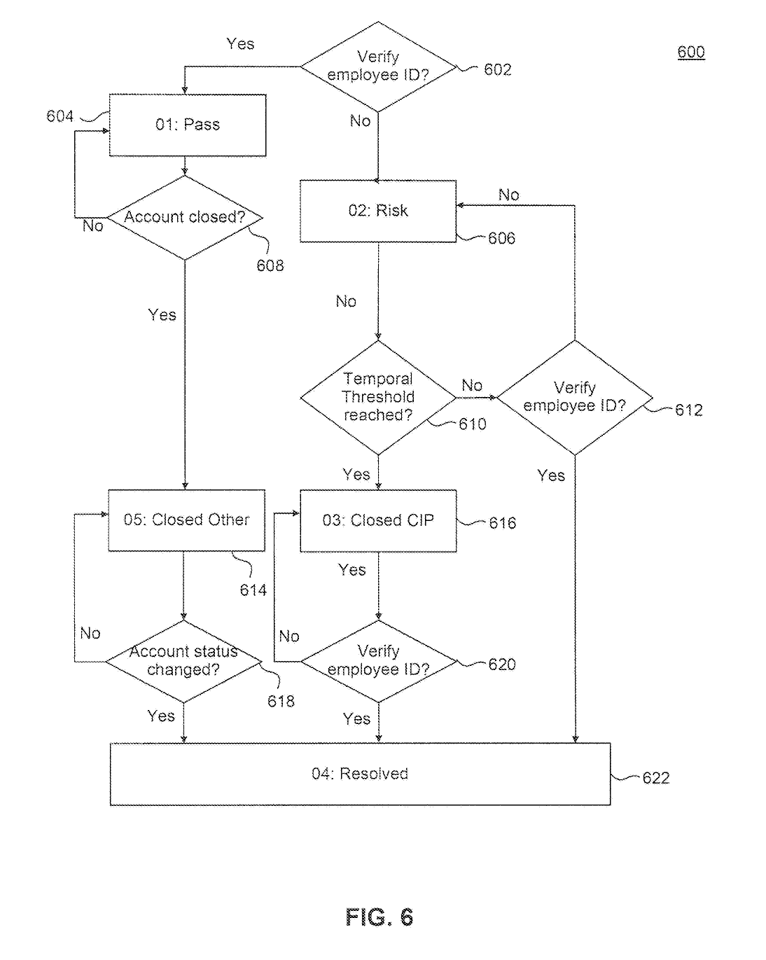

FIG. 6 is a flowchart illustrating a process 600 performed by CIP processing component 414 to determine an employee indicator based on an employee CIP status received from the bank, according to an example embodiment. Process 600 depicts steps for generating each of the five types of example employee indicators.

As discussed, a bank's CIP is performed when enrolling an employee within a CFA hosted at the bank. In step 602, CIP processing component 414 determines whether an employee's identity has been verified based on the employee's CIP status, such as ACTIVE, received from bank accounts system 300.

In step 604, CIP processing component 414 may generate PASS as the employee indicator representing that the employee has passed CIP processing and that the employee has been enrolled within the CFA hosted at the bank. In an embodiment, the PASS indicator indicates that the employee has passed initial CIP processing. In an embodiment, the PASS indicator may be associated with a contribution rule that enables available employee and available employer contribution funding. For a CFA with an on demand component, the contribution rule may be additionally associated with enabling funds within any on demand sub-accounts.

In step 608, CIP processing component 414 determines whether the employee's CFA has been closed. In an embodiment, CIP processing component 414 may receive a CFA status via an ASF from bank account system 300 indicating whether the employee's CFA is closed, e.g. a CLOSED or ACTIVE status.

In step 614, if the account has been closed, CIP processing component 414 may generate CLOSED OTHER as the employee indicator representing that the employee's CFA was closed. The CFA may be closed upon request by, for example, the employee. The CLOSED OTHER indication represents that the employee's CFA was closed but not because the employee failed the CIP.

In step 618, CIP processing component 414 determines whether the operating status of the CFA was subsequently changed or reactivated. In one scenario, an employee may change his or her mind and reopen the CFA. CIP processing component 414 may then receive a CFA status update from bank accounts system 300. If the CFA was reactivated, process 600 proceeds to step 622.

Returning back to step 602, process 600 proceeds to step 606 when the employee's identification could not be initially verified through CIP. In step 606, CIP processing component 414 may generate RISK as an employee indicator, representing that the employee has been flagged as at risk because the employee's identity could not be initially verified. In an embodiment, the RISK indicator may be associated with a contribution rule enabling employee contributions and disabling employer contributions. For a CFA with an on demand component, the contribution rule may be additionally associated with disabling or freezing any on demand sub-accounts. By preventing an employee from accessing the on demand sub-accounts, the employer reduces the amount of funds that must be recovered or retrieved from the employee if the employee fails CIP. In an embodiment, the employer may wish to provide employer contributions to its employee's CFA even though the employee's identity has not been verified by CIP. In this embodiment, the contribution funding decisions associated with the RISK indicator may be the same as that of the PASS indicator.

In step 610, CIP processing component 414 determines whether the temporal threshold discussed with regards to FIG. 2 has been reached or exceeded. In an embodiment, the temporal threshold may be a customized number of days specified by the employer and stored in CIP configuration 424 of management database 418. If the temporal threshold has not been reached, process 600 proceeds to step 612.

In step 612, CIP processing component 414 determines whether the employee's identity has been verified. In an embodiment, the employee's identity may have been verified by the bank if CIP processing component 414 receives a CIP status of ACTIVE for the employee from bank account system 300. If the employee's identity was verified, process 600 proceeds to step 622. If not, process 600 proceeds back to step 606 where the employee's indicator remains as RISK.

Returning to step 610, if the temporal threshold has been reached or exceeded, process 600 proceeds to step 616. In step 616, CIP processing component 414 may generate CLOSED CIP as the employee indicator representing that the employee's CFA was closed as having failed CIP because the employee's identity could not be verified. The CLOSED CIP indicator may be associated with a contribution rule for discontinuing or disabling both employee and employer contributions. Though not depicted, if the bank indicates that the employee has failed CIP in any of the verification steps 612 or 620, process 600 may proceed to step 616.

In traditional systems, plan management system 108 may only notify the employer that the employee has failed CIP when the bank indicates that the employee has failed CIP. Due to the lag time between when the bank determines that the employee has failed CIP and when plan management system 108 notifies employer account system 106 that the employee has failed CIP, the employer may continue to send employee or employer contributions. In this example, plan management system 108 may need to adjust the EWFR to refund the employer because any employee or employer contributions should have been discontinued.

By introducing the temporal threshold variable, the CLOSED CIP may be generated even though the bank has yet to fail the employee, because a time period set by the bank (which may be proscribed by law) to process the employee's identity through CIP has not yet been reached. However, statistically, it may be evident that by the temporal threshold, the employee is likely to fail CIP. Therefore, the temporal threshold reduces the temporal delay by the amount of time between the threshold and the set period of time to process CIP. The temporal threshold may also reduce the temporal delay between when the bank fails the employee in its CIP process and when the employer is notified of the employee failing CIP.

In step 620 and similar to step 612, CIP processing component 414 may determine whether the employee's identity has been verified. In an embodiment, the employee's identity may have been verified by the bank if CIP processing component 414 receives a CIP status of ACTIVE for the employee from bank account system 300. In an embodiment, the employee may have failed CIP because the employee did not provide identification information needed by the bank to verify his or her identity within the set period of time to perform CIP. But, the employee may subsequently provide the needed identification information or documentation. If the employee's identity was verified, step 620 proceeds to step 622.

In step 622, CIP processing component 414 may generate RESOLVED as the employee indicator representing that the employee has passed CIP processing either within or after the set period of time for performing CIP. CIP processing component 414 may generate the RESOLVED indicator upon receiving a CIP status of ACTIVE from the bank. The ACTIVE status may indicate that the employee has been enrolled within the CFA hosted at the bank. In an embodiment, the RESOLVED indicator may be associated with a contribution rule that enables available employee and available employer contribution funding. For a CFA with an on demand component, the contribution rule may be additionally associated with enabling funds within any on demand sub-accounts of the CFA. In an embodiment, the RESOLVED indicator may be associated with a rule for sending any withheld employee or employer contributions from the employer to plan management system 400.

In an embodiment, CIP processing component 414 provides more detailed and informative employee indicators, such as the RESOLVED indicator, that the bank does not provide. Whereas in step 602, the PASS indicator indicates that the employee has passed initial CIP processing and that any employee or employer contribution funding should be enabled, the RESOLVED indicator from step 622 also indicates to the employer that any withheld employee or employer contributions need to be transmitted. Employers may program contribution rules that correspond to the employee indicators provided by plan management system 108 such that employer administrators need not manually resolve any employee or employer contribution amounts for each employee when the employee's CIP status changes.

Returning to FIG. 4, contribution processing component 408 may be configured to communicate with contribution processing component 208 in employer accounts system 200 in order to reconcile an employee or employer funded contribution across the multiple systems of FIG. 1, including plan management system 108, bank accounts system 110, and card accounts system 112. Upon receiving a contribution file from employer accounts system 106, contribution processing component 408 may resolve the pledged contributions to generate a CFR as described in FIG. 2. In an embodiment, a total contribution amount for an employee may include an employee funded contribution amount and an employer funded contribution amount. In an embodiment, any employee indicators that have changed since the last time employee indicators were transmitted to employer accounts system 200 may be sent together with the CFR or in a separate file.

In an embodiment, if an employee's indicator is determined to be the RESOLVED indicator, contribution processing component 408 may be configured to include a sum of withheld employee or employer contribution funding in the CFR. In an embodiment, sending the changed employee indicator to employer account system 200 causes employer account system 200 to send the withheld sum contribution amounts.

FIG. 5 illustrates a process 500 for reducing the processing time to reconcile contribution funds in accordance with CIP resolution, according to an example embodiment. Process 500 may be performed across multiple systems, including employer account system 106, employee computer 104, bank accounts system 110, plan management system 108, and card accounts system 112. Process 500 may be performed by processing logic that may include hardware (e.g., circuitry, dedicated logic, programmable logic, microcode, etc.), software (e.g., instructions run on a processing device), or a combination thereof. In an embodiment, steps in FIG. 5 may not need to be performed in the exact order shown, as one skilled in the arts would understand. Additionally, the various components as described in FIGS. 2-4 may perform the steps.

In step 502, plan management system 108, such as plan management system 400, receives employer rules from employer accounts system 106. As described with regards to FIGS. 2 and 4, employer rules may include a temporal threshold or contribution rules that match an employee indicator to contribution funding amounts or decisions. For example, a contribution rule may match an employee indicator of PASS (representative of an employee passing CIP) with enabling an employee funded contribution and with enabling an employer funded contribution.

In step 504, employer accounts system 106 receives an employer-provided cafeteria plan offering selected by an employee via employee computer 104. Employer accounts system 106 may additionally receive employee's private information from the employee. The employee's private information may be needed by bank accounts system 110 to perform the bank-specific CIP.

In step 506, plan management system 108 receives, from employer accounts system 106, the selected cafeteria plan offering and enrollment information needed to set up a CFA of the cafeteria plan offering. The enrollment information may include the employee's private information from step 504.

In step 508, plan management system 108 configures the CFA account according to the selected cafeteria plan offering.

In step 510, plan management system 108 sends the enrollment information to bank accounts system 110. Then, bank accounts system 110 initiates its CIP process 532 as required by financial rules and regulations.

In step 512, plan management system 108 may concurrently send the enrollment information to card accounts system 112. Card accounts system 112 may configure a card usable by the employee to pay for eligible services using funds from the employee's CFA hosted at bank accounts system 110.

In some embodiments, bank account system 110 may determine whether the CFA was successfully established, and transmit this information to plan management system 108. Then, plan management system 108 may need to communicate and reconcile CFAs among bank account system 110, plan management system 108, and card accounts system 112. Process 500 focuses on CIP processing and omits these additional reconciliation steps.

In step 514, bank accounts system 110 performs its CIP to verify the employee's identity. The bank's CIP may include matching the enrollment information of the employee against the information of known persons within various public and private identification data sources as described with regards to FIG. 3. In an embodiment, bank account system 110 requests a third party to provide verification of the employee's identity. The enrollment information used to perform CIP, as described with regards to FIG. 2, may include, for example, an employee's name, date of birth, and social security number (SSN). If the employee's identity cannot be initially verified, the employee may be assigned a CIP status of PENDING. In an embodiment, bank accounts system 110 may initiate a set period of time, such as 60 days, for acquiring additional employee information to verify the employee's identity.

In step 516, plan management system 108 receives a CIP status of the employee from bank accounts system 110 via an Account Status File (ASF). In an embodiment, bank accounts system 110 may generate a CIP status that includes an ACTIVE, CLOSED, and CIP status. For example, when the employee's identity has been verified, e.g. by matching the enrollment information, the received CIP status for that employee may be ACTIVE, indicating that the employee's CFA was activated. Some individuals, such as a foreign national, may not have a credit history, and matching against the credit bureau will fail. For a foreign national, there may be no immediate method to validate his identity using any of the publicly available identification sources. In this scenario, the received CIP status may be CIP and further information may be requested from the employee.

Upon initiating CIP, bank accounts system 110 may attempt to verify an employee's identify within a set period of time, such as 60 days. Within the 60 day window, bank accounts system 110 may automatically send one or more notifications requesting additional verification documentation from the employee.

In step 518, bank accounts system 110 may request additional information or documents from the employee to verify the employee's identity. This request may be sent, for example, via phone calls, emails, or mail.

In step 520, the employee may submit requested documentation to bank accounts system 110 via employee computer 104. Subsequently, CIP process 532 may be repeated and bank accounts system 110 may re-evaluate or re-determine the CIP status of the employee as discussed in step 514. In the subsequent step 516, bank accounts system 110 may re-send CIP statuses of all the employees to plan management system 108. If the employee's identity could not be verified by day 60, bank accounts system 110 may send a CLOSED status for the employee via the ASF. Then, bank accounts system 110 may close the CFA and return the funds within the CFA to the employee.

In step 522, plan management system 108 generates an employee indicator based on received CIP statuses or employer rules as described with respect to FIG. 6.

In step 523, if any contribution rules were used, plan management system 108 matches the generated employee indicator with contribution rules.

In step 524, plan management system 108 sends, to employer accounts system 106, updated employee indicators representing any changes in employee statuses. Instead of sending all the employee indicators, a smaller number of employee indicators may be sent.

In step 526, plan management system 108 may concurrently send updated employee indicators to card accounts system 112. For example, if plan management system 108 determines the employee indicator to be CLOSED OTHER or CLOSED CIP, then card accounts system 112 may need to be notified to freeze or disable an employee's access to CFA funds within the card. In another example, if an employee has an on demand component within his or her CFA and plan management system 108 determines the employee indicator to be RISK, then card accounts system 112 may need to be notified to freeze or disable the on-demand subaccounts associated with the employee's CFA.

In step 528, plan management system 108 sends the CFR to employer accounts system 106. The CFR may include records representative of employee or employer contribution funding amounts for each employee that employer accounts system 106 needs to send plan management system 108, in order to fund the employees' respective CFAs at the bank. In an embodiment where step 523 is performed, plan management system 108 may adjust the employee or employer funded contributions based on the determined contribution funding decisions or amounts. In an embodiment, instead of sending employee indicators in step 524, plan management system 108 may send employee indicators with the CFR in step 528.

In step 530, employer accounts system 106 may send schedule contribution amounts based on just the CFR received in step 528, or both the CFR received in step 528 and changes in employee statuses received in step 524. For example, employer accounts system 106 may determine whether to enable or disable employee and employer funded contributions to an employee's CFA based on matching an employee indicator received from plan management system 108 against contribution rules stored in employer database 201. These scheduled contribution amounts may be sent at the end of each pay period. In an embodiment, the scheduled contribution amounts may also refer to employer funded contributions that may be sent less frequently, such as twice a year.

In step 534, employer accounts system 106 may send any withheld contributions for an employee, if employer accounts system 106 received the employee indicator of RESOLVED in step 524. In an embodiment, step 534 may only be performed if the employer-specific contribution rules disable employee or employer funded contributions when the employee's indicator is RISK, CLOSED OTHER, or CLOSED CIP.

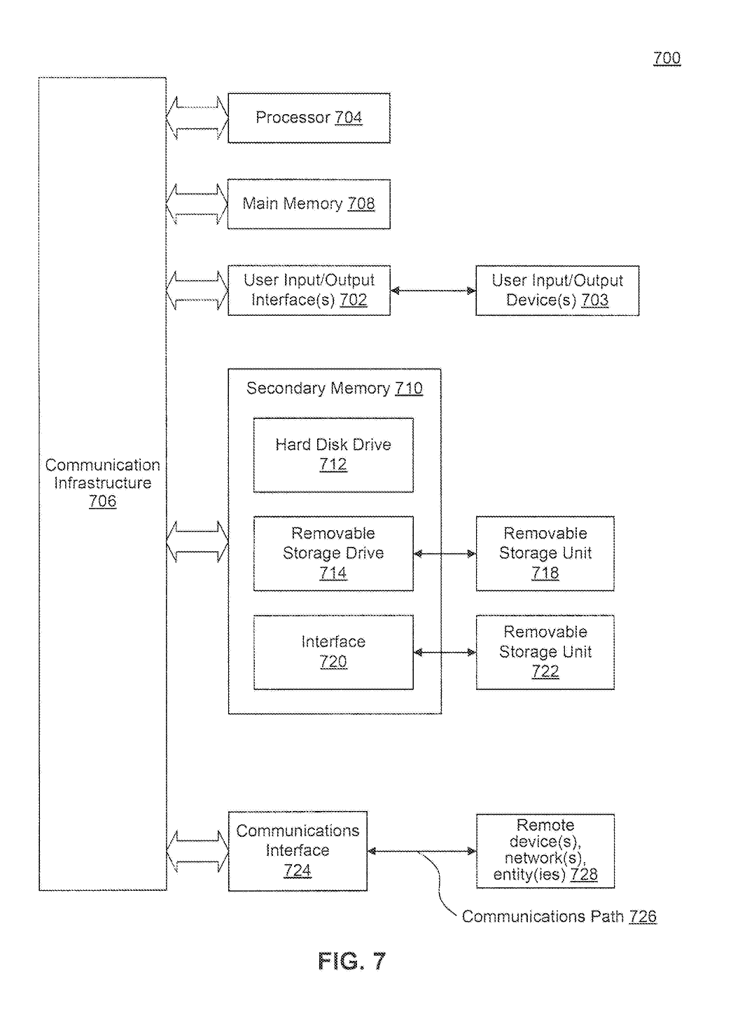

FIG. 7 is an example computer system that may be used to implement aspects of the systems illustrated in FIGS. 2-4 and 6, or which may be specially programmed to implement aspects of the processes illustrated in FIG. 5. Computer system 700 includes one or more processors (also called central processing units, or CPUs), such as a processor 704. Processor 704 is connected to a communication infrastructure or bus 706.

One or more processors 704 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that communicate with communication infrastructure 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

In an embodiment, a tangible apparatus or article of manufacture comprising a tangible computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 7. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A system for reducing synchronization time for Customer Identification Program (CIP) processing with contribution funding processing for contribution funded accounts (CFAs), comprising:
a management database configured to store a temporal threshold specified by an employer; and
a CIP processing system implemented by a management server coupled to the management database, the CIP processing system comprising:
an interface configured to receive the temporal threshold from the employer and a CIP status of an employee from a bank, the CIP status based on whether an identity of the employee has been verified before enrolling the employee into a CFA, and
a CIP configuration component configured to:
generate an employee indicator based on the received CIP status and the temporal threshold, the employee indicator associated with a contribution rule matching the employee indicator with a respective employer contribution funding decision and with a respective employee contribution funding decision, and
send the employee indicator to the employer.

2. The system of claim 1,
wherein the management database is further configured to store the contribution rule received from the employer,
wherein the CIP configuration component is further configured to determine both an employer contribution funding amount and an employee contribution funding amount for the CFA based on matching the employee indicator with the stored contribution rule, and
wherein the system further comprises:
a contribution processing component configured to request from the employer a total contribution funding amount to fund the CFA of the employee, the total contribution funding amount comprising the determined employer contribution funding amount and the determined employee contribution funding amount.

3. The system of claim 1, wherein, upon the interface receiving an initial CIP status from the bank, the CIP configuration component is further configured to:
if the CIP status indicates that the identity of the employee has been verified, output the employee indicator as having a pass status; and
if the CIP status indicates that the identity of the employee has not been verified, output the employee indicator as having a risk status associated with the employer contribution funding amount having no value while the employee indicator has the risk status.

4. The system of claim 1, wherein if the temporal threshold is exceeded, the CIP configuration component is further configured to transition the employee indicator to a close account status indicating that the employee failed the CIP processing.

5. The system of claim 4, wherein the temporal deadline specifies a number of days after initiating CIP processing and prior to a given CIP processing deadline.

6. The system of claim 3, wherein the CIP configuration component is further configured to:
transition the employee indicator from the risk status to a resolved status indicating that the identity of the employee was subsequently verified during CIP processing, wherein the risk status is associated with an updated employer contribution funding amount based on matching the transitioned employee indicator with a stored contribution rule.

7. The system of claim 1, wherein the employee indicator is associated with a current account status of the employee and with a context of the current account status, and wherein the CIP configuration component is further configured to:
if the context indicates that the employee failed CIP processing, output the employee indicator as having a first close account status to close the CFA; and
if the context indicates that the CFA was closed prior to failing CIP processing, output the employee indicator as having a second close account status to close the CFA.

8. A method for reducing synchronization time for Customer Identification Program (CIP) processing with contribution funding processing for contribution funded accounts (CFAs), comprising:
receiving, by an interface implemented on a management server coupled to a management database, a temporal threshold specified by an employer, wherein the management database is configured to store the temporal threshold;
receiving, by the interface, a CIP status of an employee from a bank, the CIP status based on whether an identity of the employee has been verified before enrolling the employee into a CFA at the bank;
generating, by a CIP configuration component implemented on the management server, an employee indicator based on the received CIP status and the temporal threshold, the employee indicator associated with a contribution rule matching the employee indicator with a respective employer contribution funding decision and with a respective employee contribution funding decision; and
sending the employee indicator to the employer.

9. The method of claim 8, further comprising:
storing the contribution rule received from the employer;
determining both an employer contribution funding amount and an employee contribution funding amount for the CFA based on matching the employee indicator with the stored contribution rule; and
requesting from the employer a total contribution funding amount to fund the CFA of the employee, the total contribution funding amount comprising the determined employer contribution funding amount and the determined employee contribution funding amount.

10. The method of claim 7, wherein the CIP status is an initial CIP status generated upon enrolling in the CFA, wherein the generating comprises:
if the identity of the employee was initially verified, outputting the employee indicator as having a pass status; and
if the identity of the employee was not initially verified, outputting the employee indicator as having a risk status that is associated with the employer contribution funding amount having no value while the employee indicator has the risk status.

11. The method of claim 7, further comprising:
if the temporal threshold is exceeded, transitioning, by the CIP configuration component, the employee indicator to a close account status indicating that the employee failed the CIP processing.

12. The method of claim 11, wherein the temporal deadline specifies a number of days after initiating CIP processing and prior to a given CIP processing deadline.

13. The method of claim 9, further comprising:
transitioning the employee indicator from the risk status to a resolved status indicating the that identity of the employee was subsequently verified during CIP processing, wherein the risk status is associated with an updated employer contribution funding amount based on matching the transitioned employee indicator with a stored contribution rule.

14. The method of claim 7, wherein the employee indicator is associated with a current account status of the employee and with a context of the current account status, the method further comprising:
if the context indicates that the employee failed CIP processing, outputting the employee indicator as having a first close account status to close the CFA; and
if the context indicates that the CFA was closed prior to failing CIP processing, outputting the employee indicator as having a second close account status to close the CFA.

15. A non-transitory computer readable storage medium having instructions stored thereon that, in response to execution by a computing device, cause the computing device to perform operations for reducing synchronization time for Customer Identification Program (CIP) processing with contribution funding processing for contribution funded accounts (CFAs), the operations comprising:
receiving, by an interface implemented on a management server coupled to a management database, a temporal threshold specified by an employer, wherein the management database is configured to store the temporal threshold;
receiving, by the interface, a CIP status of an employee from a bank, the CIP status based on whether an identity of the employee has been verified before enrolling the employee into a CFA at the bank;
generating, by a CIP configuration component implemented on the management server, an employee indicator based on the received CIP status and the temporal threshold, the employee indicator associated with a contribution rule matching the employee indicator with a respective employer contribution funding decision and with a respective employee contribution funding decision; and
sending the employee indicator to the employer.

16. The non-transitory computer readable storage medium of claim 15, the operations further comprising:
storing the contribution rule received from the employer;
determining both an employer contribution funding amount and an employee contribution funding amount for the CFA based on matching the employee indicator with the stored contribution rule; and
requesting from the employer a total contribution funding amount to fund the CFA of the employee, the total contribution funding amount comprising the determined employer contribution funding amount and the determined employee contribution funding amount.

17. The non-transitory computer readable storage medium of claim 15, wherein the CIP status is an initial CIP status generated upon enrolling in the CFA, the operations further comprising:
if the identity of the employee was initially verified, outputting the employee indicator as having a pass status; and
if the identity of the employee was not initially verified, outputting the employee indicator as having a risk status that is associated with the employer contribution funding amount having no value while the employee indicator has the risk status.

18. The non-transitory computer readable storage medium of claim 15, the operations further comprising:
if the temporal threshold is exceeded, transitioning, by the CIP configuration component, the employee indicator to a close account status indicating that the employee failed the CIP processing.

19. The non-transitory computer readable storage medium of claim 15, wherein the temporal deadline specifies a number of days after initiating CIP processing and prior to a given CIP processing deadline.

20. The non-transitory computer readable storage medium of claim 15, the operations further comprising:
transitioning the employee indicator from the risk status to a resolved status indicating the that identity of the employee was subsequently verified during CIP processing; and
determining an updated employer contribution funding amount based on matching the transitioned employee indicator with a stored contribution rule.

21. The non-transitory computer readable storage medium of claim 13, wherein the employee indicator is associated with a current account status of the employee and with a context of the current account status, the method further comprising, the operations further comprising:
if the context indicates that the employee failed CIP processing, outputting the employee indicator as having a first close account status to close the CFA; and
if the context indicates that the CFA was closed prior to failing CIP processing, outputting the employee indicator as having a second close account status to close the CFA.
